(19) United States
(12) Patent Application Publication
(10) Pub. No.: US 2025/0304106 A1
(43) Pub. Date: Oct. 2, 2025

(54) METHOD AND SYSTEM FOR TRACKING BY A VEHICLE

(71) Applicant: May Mobility, Inc., Ann Arbor, MI (US)

(72) Inventors: Anthony Rodriguez, Ann Arbor, MI (US); Edwin B. Olson, Ann Arbor, MI (US)

(73) Assignee: May Mobility, Inc., Ann Arbor, MI (US)

(21) Appl. No.: 19/091,533

(22) Filed: Mar. 26, 2025

Related U.S. Application Data
(60) Provisional application No. 63/570,079, filed on Mar. 26, 2024.
(60) Provisional application No. 63/574,710, filed on Apr. 4, 2024.

(51) Int. Cl. B60W 60/00; G01S 17/931; G06V 20/58

(52) U.S. Cl. CPC B60W 60/001; G01S 17/931; G06V 20/58

(57) ABSTRACT

A method can include: determining a set of measurements; determining a visibility representation; determining a set of observations; generating a set of hypotheses; determining a set of tracks; and/or any other suitable elements. Additionally or alternatively, the method can optionally include planning a trajectory for the vehicle and/or any other suitable elements. The method functions to track objects and the uncertainty of existence thereof in the vehicle's environment over time.

### CROSS REFERENCE TO RELATED APPLICATIONS

This application claims the benefit of U.S. Provisional Application No. 63/574,710 filed 4 Apr. 2024, and U.S. Provisional Application No. 63/570,079, filed 26 Mar. 2024, each of which is incorporated herein in its entirety by this reference.

### TECHNICAL FIELD

This invention relates generally to the autonomous vehicle field, and more specifically to a new and useful system and method for tracking by a vehicle in the autonomous vehicle field.

### BRIEF DESCRIPTION OF THE FIGURES

FIG. 1 is a schematic representation of a variant of the system.

FIG. 2 is a schematic representation of a variant of the method.

FIG. 3 is a schematic representation of a variant of updating the set of tracks.

FIG. 4 is an illustrative example of a variant of the method.

FIG. 5 is an example of a variant of generating a set of hypotheses.

FIGS. 6A-6B are examples of variants of different tracks at a timestep and different hypotheses for a track over time, respectively.

FIG. 7 is an illustrative example of a probabilistic graphical model.

FIGS. 8A-8B are examples of variants of representations of a scene and a visibility representation representing visibility of the scene.

FIGS. 9A-9C are examples of variants of determining a probability of detection.

FIG. 10 is an example of a variant of observations and tracks.

FIGS. 11A-11B are examples of graphs of probability of existence.

FIGS. 12A-12C are examples of graphs of probability of existence over time.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

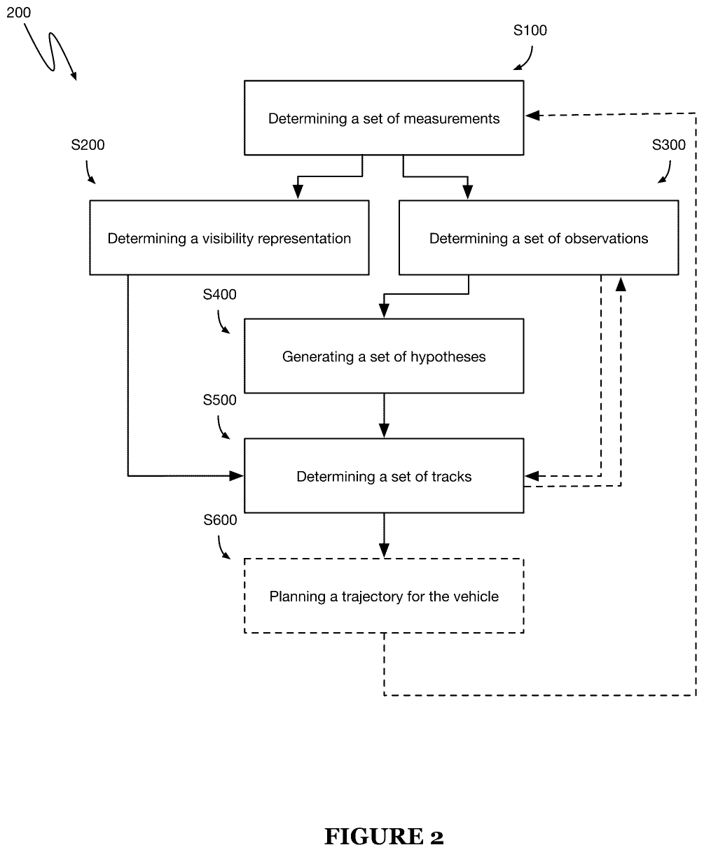

The method 200, an example of which is shown in FIG. 2, the can include: determining a set of measurements S100; determining a visibility representation S200; determining a set of observations S300; generating a set of hypotheses S400; determining a set of tracks S500; and/or any other suitable elements. Additionally or alternatively, the method 200 can optionally include planning a trajectory for the vehicle S600, and/or any other suitable elements. The method functions to track objects and the uncertainty of existence thereof in the vehicle's environment over time.

Variants of the method can incorporate a probability of detection for a region into updates of a probability of existence of an object within the region. Sensors of a sensor suite can capture measurements of a vehicle's context, which can be processed by a perception subsystem 121 (e.g., including an object detection system, etc.) to identify and/or locate objects in a scene. Additionally, measurements captured by the sensor suite (e.g., lidar measurements, etc.) can be processed to generate a 2D visibility map representing visibility of the ground around the vehicle. In the event that a tracked object (e.g., wherein tracks can be generated using prior measurements, etc.) is not observed in the set of measurements, a probability of existence of the tracked object can be differentially scaled according to its probability of detection as indicated by values in the 2D visibility map. Tracks determined using different representations of the environment can be evaluated alongside each other to determine hypotheses of the most likely next observation of the object represented by the track.

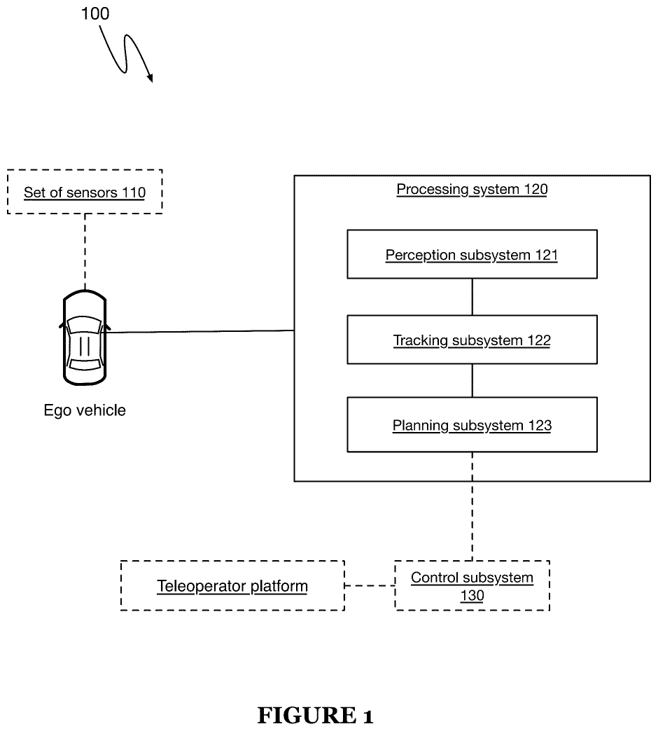

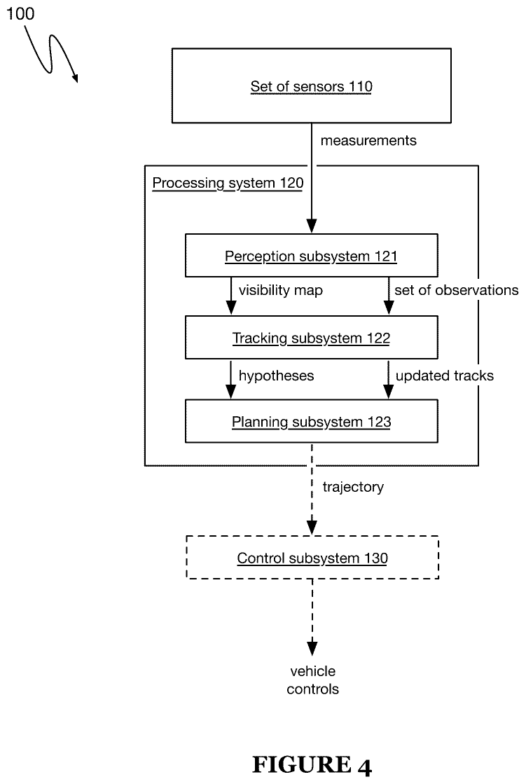

As shown in FIG. 1, a system 100 for vehicle tracking can include a set of computing and/or processing subsystems (e.g., example shown in FIG. 4). Additionally or alternatively, the system can include and/or interface with any or all of: a set of models and/or algorithms, a set of sensors, a control subsystem, and/or any other suitable components. Further additionally or alternatively, the system can include and/or interface with any or all of the components as described in any or all of: U.S. application Ser. No. 16/514,624, filed 17 Jul. 2019; U.S. application Ser. No. 16/505,372, filed 8 Jul. 2019; U.S. application Ser. No. 16/540,836, filed 14 Aug. 2019; U.S. application Ser. No. 16/792,780, filed 17 Feb. 2020; U.S. application Ser. No. 17/365,538, filed 1 Jul. 2021; U.S. application Ser. No. 17/550,461, filed 14 Dec. 2021; U.S. application Ser. No. 17/554,619, filed 17 Dec. 2021; U.S. application Ser. No. 17/712,757, filed 4 Apr. 2022; U.S. application Ser. No. 17/826,655, filed 27 May 2022; U.S. application Ser. No. 18/072,939, filed 1 Dec. 2022; and U.S. application Ser. No. 18/109,689, filed 14 Feb. 2023; each of which is incorporated herein in its entirety by this reference.

As shown in FIG. 2, the method 200 for tracking by a vehicle can include: determining a set of measurements S100, determining a visibility representation S200, determining a set of observations S300, generating a set of hypotheses S400, determining a set of tracks S500, optionally planning a trajectory for the vehicle S600, and/or any other suitable processes. Further additionally or alternatively, the method 200 can include and/or interface with any or all of the processes as described in any or all of: U.S. application Ser. No. 16/514,624, filed 17 Jul. 2019; U.S. application Ser. No. 16/505,372, filed 8 Jul. 2019; U.S. application Ser. No. 16/540,836, filed 14 Aug. 2019; U.S. application Ser. No. 16/792,780, filed 17 Feb. 2020; U.S. application Ser. No. 17/365,538, filed 1 Jul. 2021; U.S. application Ser. No. 17/550,461, filed 14 Dec. 2021; U.S. application Ser. No. 17/554,619, filed 17 Dec. 2021; U.S. application Ser. No. 17/712,757, filed 4 Apr. 2022; U.S. application Ser. No. 17/826,655, filed 27 May 2022; U.S. application Ser. No. 18/072,939, filed 1 Dec. 2022; and U.S. application Ser. No. 18/109,689, filed 14 Feb. 2023; each of which is incorporated herein in its entirety by this reference, or any other suitable processes performed in any suitable order.

In variants, tracks preferably include a trajectory and a history of states (e.g., inferred from observations when they exist or inferred from a model when they observations don't exist, such as when an object is occluded) which correspond to the same real-world object (and/or an identifier associated therewith). For instance, tracks can be associated with a kinematic data (e.g., indicating pose, velocity, acceleration, size, scale, orientation, heading, etc.), temporal data (e.g., time of first observation of object represented by track, current age, last update timestamp, a history of past states, etc.), a probability of existence, track quality, classification (e.g., “truck,” “car,” “pedestrian,” etc.), an instance ID, visual features (e.g., color histogram, texture, etc.), shape parameters, occlusion status (e.g., whether or not the track is currently in a visible region, etc.) and/or any other suitable information.

However the system can be alternatively configured and/or the method can be alternatively performed.

### 2. Benefits.

Variations of the technology can afford several benefits and/or advantages.

The system and method for vehicle tracking can confer several benefits over current systems and methods.

First, variants of the technology can confer the benefit of maintaining a historical awareness of all explanations for the vehicle's environment, which enables, for instance, the system to be able to alter (e.g., adjust, reconstruct, etc.) the vehicle's historical understanding if new information makes that historical understanding incorrect. This can be in contrast with conventional tracking processes, which might keep only the most likely world representation at any given time, thereby requiring that detected objects and associated motion information (aka “tracks”) be replaced if a discrepancy arises with current and past understandings. In preferred variants, for instance, the system and/or method utilize multiple competing representations (open versus closed world) rather than (and/or in addition to) relying on a single input representation to self-correct over time. This can enable the system and/or method to further confer the benefit of allowing the vehicle to maintain and utilize a rich understanding of the evolution of its environment to adapt quickly to new scenarios, drive in a smooth and human-like manner, increase an accuracy of its observations (e.g., object detections, etc.), and/or otherwise leverage a rich historical understanding amidst uncertainty.

Second, in some variants of the technology, tracking of a probability of existence of object tracks in addition to other object attributes (e.g., classification, shape, size, and/or speed; and/or confidences thereof, etc.) enables the system to monitor objects even when information about those objects is sparse or unreliable. This can especially improve vehicle decision-making during unprotected turns, where the probability of a short-term or long-term vehicle occlusion is high. For example, a distant object behind a set of trees and road signs may be detected in only a small proportion of a time series of measurements. Instead of assuming the object does not exist, the method can retain a track of the object but assign the track a low probability of existence, enabling the vehicle to be aware of a relatively long record of information about the object in the event that the object's probability of existence becomes higher (e.g., when the vehicle comes closer to the object, etc.). The low probability of existence, however, prevents the vehicle from making drastic decisions based on low-quality information. The tradeoff between risk and probability of existence of a source of risk can enable the vehicle to make higher-quality decisions about vehicle control.

Third, in some variants of the technology, calculating a probability of detection (e.g., using a visibility map, etc.) can improve the evaluations of both detection and non-detection of objects with respect to the probability of existence of the object. For conventional systems which do not consider the likelihood of detection, an extant object may be incorrectly classified as not existing when the object is occluded for a period of time. By using a visibility representation, the method more accurately depreciates the probability of an object existing. For example, probability of existence for an object in a region which is occluded is less affected by non-observation than probability of existence for an object in a region which is visible.

Fourth, variants of the technology confer the benefit of utilizing multiple, diverse methods for observing the environment (equivalently referred to herein as a world) of the vehicle to produce observations (e.g., detections of objects), wherein these multiple ways of observing the world and their results are considered and propagated together while performing a tracking process. This can further confer benefits of increasing the robustness and accuracy of observations made by the tracking system, leveraging benefits from all of the diverse methods while minimizing their individual limitations, providing redundancy to the tracking system, and/or conferring other benefits.

Additionally, in some variants, hypotheses regarding the current existence and/or features (e.g., shape, size, location, velocity, etc.) of objects previously detected in the vehicle's environment are produced in the method described below with various techniques (e.g., a learned processes, non-learned processes, etc.) and optionally different data sources, where these hypotheses from multiple sources are simultaneously propagated through the tracking process both individually and collectively, and optionally beyond the tracking process (e.g., in planning).

However, variations of the technology can additionally or alternately provide any other suitable benefits and/or advantages.

### 3. System.

The system 100 functions to determine and maintain an accurate understanding of the objects in its environment and perform downstream decision-making based on this understanding. Additionally, the system 100 can function to: handle uncertainty in its environment (e.g., through analyzing and preserving multiple explanations for environmental observations), adjusting its historical understanding (e.g., if new and conflicting information is received), simultaneously overcome generalization limitations of heuristic tracking while mitigating aleatoric and epistemic error in learned models, and/or the system can be otherwise suitably configured for any other functions.

The system includes and/or interfaces with an autonomous vehicle (equivalently referred to herein as a “vehicle”) which can be configured for any or all of: fully autonomous driving, partially autonomous driving, manual driving, Advanced Driver Assistance Systems (ADAS), and/or any types of driving. In preferred variants, the vehicle is configured for Level 5 and/or Level 4 autonomy. Additionally or alternatively, the vehicle can be operable at less than Level 4 autonomy, and/or any combination of autonomy levels.

The system (e.g., through the vehicle) can interface with and/or include a set of sensors 110, the set of sensors configured to collect data associated with the vehicle's surroundings. At least a portion of the sensors preferably includes sensors configured to sample data including depth information (e.g., 3D data), such as: Lidar Detection and Ranging (Lidar) sensors, Radar sensors, any other sensors, and/or any combination of sensors. The set of sensors can additionally or alternatively include sensors configured to capture 2-dimensional (2D), such as cameras (e.g., RGB cameras). Additionally or alternatively, the set of sensors can include sensors producing data with other dimensionality (e.g., 2.5D, 3D, etc.), other optical sensors (e.g., infrared sensors), audio sensors, location sensors (e.g., Global Positioning Satellite [GPS] sensors), and/or any other suitable sensors. The system can optionally be simultaneously compatible with Late Fusion (detection on all sources independently) and Early Fusion (detection on all sources simultaneously prior to tracker input), or any combination thereof. This can be in contrast with conventional systems, which currently only operate in one of these paradigms.

The sensors can be: mounted to an exterior of the vehicle, mounted to an interior of the vehicle, reversibly and/or movably mounted to the vehicle, offboard the vehicle (e.g., in an environment of the vehicle, on other vehicles, etc.), otherwise located, and/or have any combination of locations.

In a preferred variant, the set of sensors includes: a set of Lidar sensors (e.g., multiple, between 4-8, 5, etc.), a set of Radar sensors (e.g., multiple, between 4-8, 6, etc.), a set of cameras (e.g., multiple), and/or any other sensors.

The system can include a set of models (e.g., implementing learned methods and/or algorithms (e.g., implementing non-learned methods, etc.) and/or logic, which can function to: produce the sets of observations, evaluate the sets of observations (e.g., to generate hypotheses), produce and/or select object tracks (e.g., representations of objects) for planning, and/or perform any other functions. The set of models and/or algorithms and/or logic can be any or all of: trained (e.g., heuristic, probabilistic, etc.), non-trained, or any combination.

The system preferably includes and/or interfaces with a processing system 120 which can include a set of computing subsystems (e.g., computers, processors, CPUs, GPUs, SoCs, etc.) and can function to perform any or all processes of the method 200. Additionally or alternatively, the processing system 120 can function to trigger and/or otherwise control the timing of any or all of the method, include memory and/or storage, and/or otherwise function.

The processing system 120 and/or computing subsystems thereof can store and/or run the perception subsystem 121, which 121 functions to detect and/or classify objects in the scene. The perception subsystem 121 can perform S200, S300 and/or any other suitable steps. The perception subsystem 121 can include an object detector, which can detect and/or classify objects within a measurement or set of measurements. In variants, the perception subsystem 121 can perform S300 and/or any other suitable processes. In an example, the object detector can include multiple types of detection processes (e.g., learned and/or non-learned processes, etc.). However, the perception subsystem can be otherwise configured.

The processing system 120 and/or computing subsystems thereof can store and/or run the tracking subsystem 122 (equivalently referred to herein as the “tracker” of the vehicle), which functions to track detected objects over time. The tracking subsystem 122 can perform S400, S500 and/or any other suitable steps. In variants, the tracking subsystem However, the tracking subsystem 122 can be otherwise configured.

The processing system 120 and/or computing subsystems thereof can store and/or run a planning subsystem 123 which functions to determine a set of instructions for the vehicle. The planning system 123 can perform S600 and/or any other suitable steps. However, the planning subsystem 123 can be otherwise configured.

The processing system 120 and/or computing subsystems thereof preferably located at least partially onboard the vehicle, but can additionally or alternatively be located partially or fully offboard (in a cloud computing environment, in an edge computing arrangement, etc.).

Additionally or alternatively, the system can include and/or interface with a control system 130 (e.g., a control system onboard the vehicle configured to convert determined trajectories into vehicle controls, etc.), a set of actuation subsystems, a teleoperation platform, and/or any other components. In variants, the teleoperation platform can perform the method 200 and/or portions thereof in communication with the vehicle.

However, the system can include any other suitable components.

### 4. Method.

The method 200, an example of which is shown in FIG. 2, the can include: determining a set of measurements S100; determining a visibility representation S200; determining a set of observations S300; generating a set of hypotheses S400; determining a set of tracks S500; and/or any other suitable elements. Additionally or alternatively, the method 200 can optionally include planning a trajectory for the vehicle S600, and/or any other suitable elements. The method functions to track objects and the uncertainty of existence thereof in the vehicle's environment over time.

All or portions of the method can be performed in real time (e.g., responsive to a request), iteratively, concurrently, asynchronously, periodically, and/or at any other suitable time. In a first variant, steps of the method can be performed on each iterative set of measurements determined in S100. In a second variant, steps of the method can be performed at a predetermined time interval, frame interval, and/or responsive to any other suitable condition. However, steps of the method can be performed responsive to any other suitable condition. In an example, the method can be performed repeatedly to maintain and/or update a tracking history for objects (e.g., world agents, etc.) detected in the measurements. All or portions of the method can be performed automatically, manually, semi-automatically, and/or otherwise performed. The method can be performed on the computing and/or processing subsystems, and/or can be otherwise suitably executed/performed.

Determining a set of measurements S100 functions to determine data about the vehicle's surroundings. S100 can be performed by the set of sensors 110, but can alternatively or alternatively include receiving, at the processing system, measurements collected by the set of sensors, and/or can be performed by another system component(s).

S100 is preferably performed iteratively in real-time with S200 during vehicle operation, but can additionally and/or alternatively be performed at any other time. The frequency can increase during periods of high uncertainty, risk, and/or any other conditions. The set of measurements can be or include camera data (e.g., images, etc.), lidar, radar, IMU, and/or any other measurements. The set of measurements can surround the vehicle (e.g., 360° coverage), but can alternatively include partial coverage, and/or any other coverage. The coverage of different sensor modalities can overlap, but can alternatively not overlap.

The measurements can depict the ground plane, other agents within the scene (pedestrians, other vehicles, animals, etc.), environmental elements (e.g., trees, hydrants, sidewalks, etc.), and/or any other representation(s).

However, determining a set of measurements S100 may be otherwise performed.

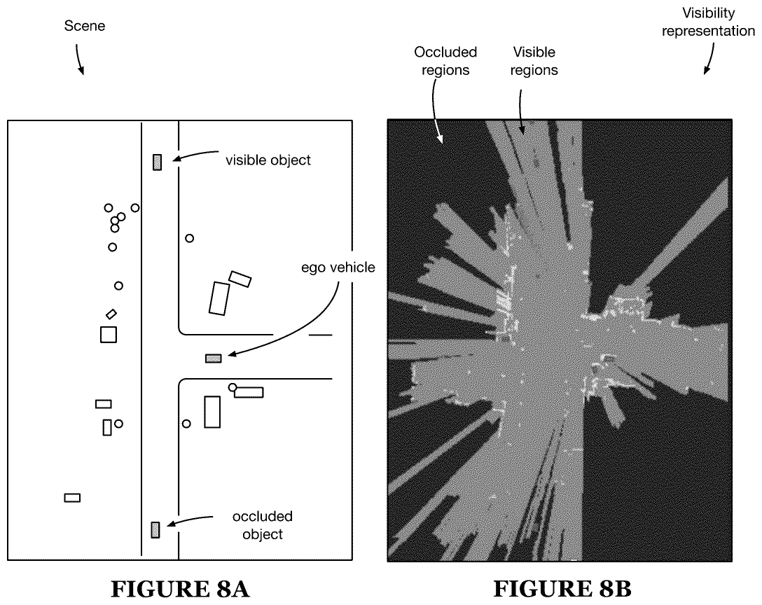

Determining a visibility representation S200 functions to determine a representation of the environment which distinguishes visible regions from invisible regions (e.g., example shown in FIG. 8A and FIG. 8B).

S200 is preferably performed by the perception subsystem 121, but can alternatively be performed by another suitable subsystem.

The visibility representation can be a 2D map, 3D map, point cloud, spherical projection, set of 2D/3D shapes, a 2D or 3D polar plot, a visibility graph, a shadow map, a viewshed, aspect graph, and/or any other representation format. In a specific example, the visibility map can be a 2D map representing a visibility of the ground plane from overhead. The visibility representation can alternatively be 2.5D (e.g., wherein the visibility map follows contours of the ground).

In variants, the visibility representation can represent different aspects of visibility. In a first variant, the visibility representation can represent visibility within a reference plane. In a first example, the reference plane can be at ground level. In a second example, the reference plane can be above ground level (0.5 feet, 1 foot, 2 feet, 4 feet, etc.). In a second variant, the visibility representation can represent visibility at a surface (e.g., the ground surface). In a third variant, the visibility representation can represent visibility within a region defined by an elevation range from a point. The lower bound can be (−5°, −3°, −1°, 0° etc.). The upper bound can be (0°, 1°, 3°, 5°, etc.). The point can be 1 foot, 2 feet, 4 feet, 5 feet, etc. off the ground. In a fourth variant, the visibility representation can represent visibility with a height range relative to a reference plane. The height range can be 1 foot, 2 feet, 4 feet, 6 feet, 8 feet, 10 feet, etc. In a fifth variant, the visibility representation can represent visibility within each of a set of discrete regions (e.g., within voxels of a 3D grid or pixels of a 2D grid overlaid over the environment, etc.).

Values within the visibility representation can be discrete, continuous, binary, non-binary a probability distribution, single-dimensional, multi-dimensional, and/or can take any other format. In a first variant, values within the visibility representation can be binary. For instance, a binary value within the visibility representation can indicate whether an object is visible or invisible. Alternatively, binary values can indicate a visibility confidence above (or below) a predefined threshold. The binary values can be within distance threshold of detected lidar point. In this variant, the visibility representation can be a binary map. In a second variant, values within the visibility representation can be continuous (e.g., representing probability of visibility, etc.). The continuous values can be a function of air transparency, continuous visible area, confidence, length of time an area is visible, distance, length of continuous visibility in a vertical line off a reference plane, percentage of continuous visibility along a vertical line from a reference plane, percentage of continuous visibility within a region.

The visibility representation can be determined based on one or more determination methods. In a first variant, the visibility representation can be determined based on lidar measurements (e.g., ray casting to points of the lidar measurement). In a second variant, the visibility representation can be determined based on a depth map (e.g., ray casting to each pixel of the depth map, etc.). In a third variant, the visibility representation can be determined based on a 3D environmental representation comprising 3D shapes determined from measurements (e.g., 3D visibility map determined by ray casting within the 3D environmental representation, etc.). In a fourth variant, the visibility representation can be determined based on an occupancy grid. In a fifth variant, the visibility representation can be determined based on a prior visibility representation.

The visibility representation can be determined using any and/or all of ray casting (e.g., with projection), ray tracing, sweep line algorithm, shadow mapping, binary space partitioning (BSP), sector-based methods, occlusion culling, and/or any other visibility determination methods. In an example, a set of rays can be cast to observed lidar points within a point cloud, and the rays can be projected onto a 2D surface with a constant thickness or linearly-increasing thickness with distance, and/or any other thickness configuration.

In variants where the visibility representation is 2D (and/or 2.5D) and based on visibility within a 3D space (e.g., a lidar point cloud, a 3D model of the environment, etc.), values within the visibility representation can be determined through multiple methods. In a first variant, values can be aggregated over a vertical line at each 2D coordinate of the 3D space. In a second variant, values can be projections of the cast rays to visible points in a 3D representation onto a reference plane. In a third variant, values can be aggregated over a local 2D or 3D region at each 2D coordinate of the visibility representation. The local region can be within 1 foot, 2 feet, 5 feet, 10 feet, or any open or closed range or value therebetween. The local region can alternatively be less than 1 foot or greater than 10 feet. The local region can be a function of distance from the vehicle and/or any other parameter. Additionally, the aggregation can average visibility, weighted average visibility, median visibility, and/or any other visibility measurement.

The visibility representation can be determined using measurements at current timestep, but can alternatively be generated in the prior timestep and/or iteration of S200 (and/or used at next timestep; with or without correcting for delta pose of the vehicle, etc.), and/or can be determined with any other timing/relationship.

However, determining a visibility representation s200 may be otherwise performed.

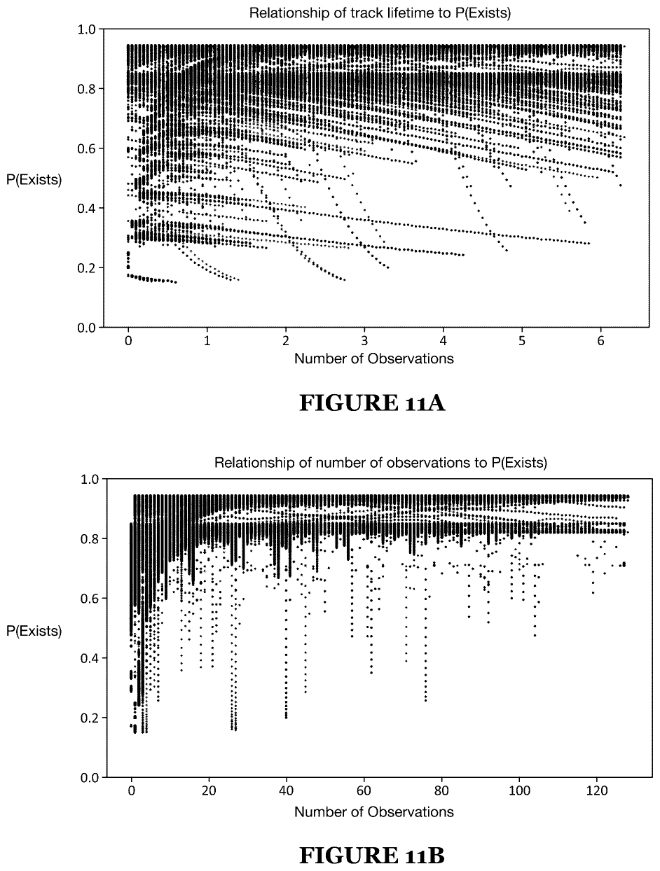

Generating multiple sets of observations S300 functions to produce a robust and diverse set of object observations (e.g., object detections, etc.) which can be used to explain how the vehicle's environment is evolving over time (e.g., examples shown in FIG. 11A and FIG. 11B). Additionally or alternatively, the multiple sets of observations can function to: provide redundancy and/or prevent shortcomings associated with individual processes for producing observations; adequately ensure that sufficient possibilities and/or explanations for vehicle observations are determined and considered; and/or any other functions. S300 is preferably performed by the perception subsystem 121 but can alternatively be performed by another suitable system component.

S300 is preferably performed on the set of measurements but can alternatively be performed on any other suitable set(s) of data. S300 can be performed on Lidar measurements, camera measurements, Radar measurements, depth maps, and/or any other suitable data. S200 and S300 can be performed using distinct sets of measurements, overlapping sets of measurements, and/or the same sets of measurements. In variants where different sets of measurements are used for S200 and S300, the sets of measurements can be in the same modality or different modalities. In an example, S300 is performed on camera measurements and S200 is performed on Lidar data. However, S300 can be performed using any suitable data.

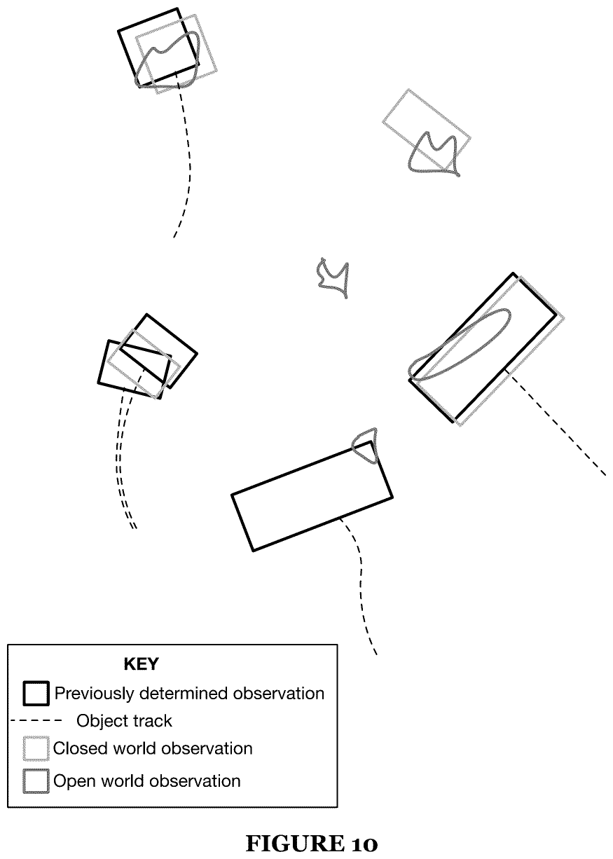

An observation can include any or all of: an identification of an object, a classification of an object (e.g., car, bicycle, pedestrian, stationary object, dynamic object, etc.), state information (e.g., a learned encoding, a learned latent state vector, position, velocity, etc.) associated with the object, geometric information (e.g., shape, size, etc.), and/or any other information associated with the object and/or environment (e.g., predicted route of object, lane of object, etc.). Additionally or alternatively, an observation can refer to a subset of points (e.g., grouping, cluster, etc.) that has the potential to be an object (e.g., but has not yet been identified and/or classified). The multiple sets of observations can include the same types of information relative to each other, different types of information relative to each other, and/or any combination of types of information. The observation can optionally include an associated 2D or 3D bounding box and/or a bounding hull of another suitable shape (e.g., example shown in FIG. 10). In an example, the shape and/or size of a bounding hull of the observation can be determined based on a classification of the observation. For example, a generic car-shaped hull can be fit to observation corresponding to the “car” classification. In this example, a set of generic hull shapes can be stored in association with a known scale value and can be fit to an observation based on a classification of the observation while substantially (e.g., +−5%, 10%, 15%, etc.) preserving the scale of the generic hull shape.

The multiple sets of observations are preferably produced through multiple (e.g., 2, 3, 4, etc.) different types of detection processes (e.g., performed by an object detector of the perception subsystem 121, etc.). In a preferred variant, for instance, a first set of observations is produced with one or more trained models implementing learned process(es), and a second set of observations is produced with one or more algorithms implementing non-learned processes. Examples of learned processes include inference with regressions, deep learning models, and/or other learned processes. Examples of non-learned methods can include classical approaches, rule-based methods, expert systems, heuristic approaches, deterministic approaches, hand-crafted algorithms, analytic methods and/or other suitable techniques. Additionally or alternatively, other processes can be used, additional processes can be used, multiple trained processes (e.g., each using a different model architecture) can be used, multiple non-trained processes (e.g., each using a different algorithm) can be used, and/or the sets of observations can be otherwise suitably produced. The different processes for generating observations can use: the same set of measurements and/or stored environmental representations, different (e.g., partially overlapping, non-overlapping, etc.) sets of measurements and/or stored environmental representations, and/or any other data or combinations of data. For instance, in some variants, a larger set of sensor data (e.g., from all types of sensors on the vehicle, from all sensors on the vehicle, etc.) is used for a first process (e.g., trained model inference) than a set used for a second process (e.g., algorithmic process).

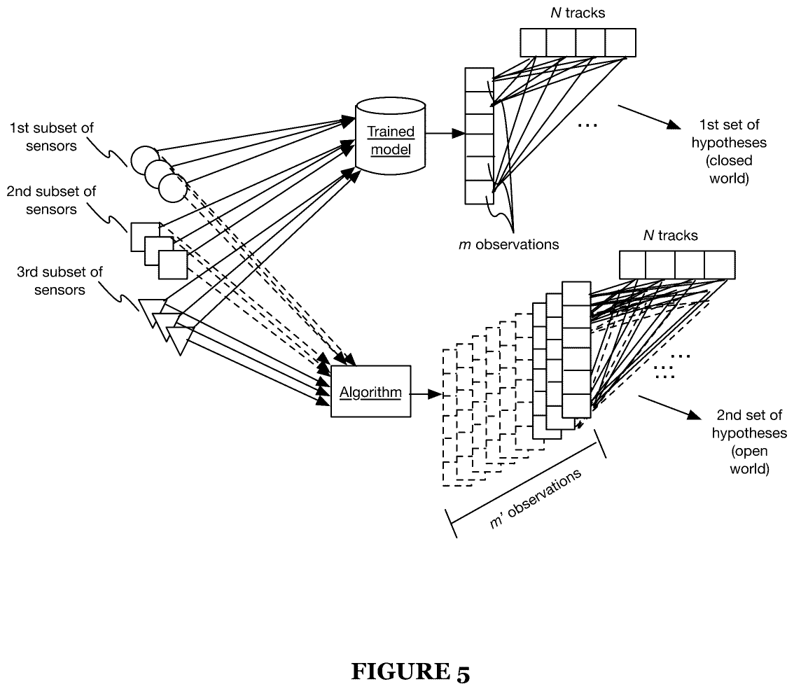

In a preferred variant, at a given time, a trained detection process produces a set of m observations (equivalently referred collectively herein as a “closed world representation”), and an algorithmic (e.g., using non-learned methods, classical methods, etc.) detection process produces a set of m′ observations (equivalently referred to herein as an “open world representation”), wherein m and m′ can be: the same, different, or otherwise valued. In an example shown in FIG. 5, a first set of sensor data (e.g., from Radar, Lidar, and cameras) is processed in the trained detection process, whereas only a subset of that data (e.g., camera data) is processed in the algorithmic detection process. The trained detection process produces a single set of m observations, whereas the algorithmic detection process produces a single set of observations per sensor, resulting collectively in m′ observations. In variants, observations from the same detection processes (e.g., algorithmic and/or trained, etc.) or different detection processes can refer to the same real-world object.

In a particular example, the closed world representation is produced through a trained cuboid detection process, and the open world representation is produced through a hand-engineered algorithm, wherein the open world representation is associated with higher noise than the closed world representation, but is also less likely to miss any information associated with the vehicle's world. In another particular example, a cuboid representation (e.g., identification of 3D cuboids representation of objects) and a segmentation representation (e.g., identification of object contours) are both produced through machine learning model processes, where these representations are combined in the tracking subsystem.

Additionally or alternatively, S300 can be otherwise suitably performed and include any other suitable processes. However, determining a set of observations S300 may be otherwise performed.

Generating a set of hypotheses S400 functions to provide a variety of explanations for how the vehicle's environment has evolved over time. Additionally, the hypotheses can be used to update the object tracks (e.g., trajectories, movement between frames of sensor data, etc.) and/or otherwise be suitably used. S400 is preferably performed by the tracking subsystem 122 but can alternatively be performed by another suitable system component.

S400 is preferably performed in response to S300 and based on the sets of observations (e.g., m and m′ observations), but can additionally or alternatively be performed at other times. S400 is further preferably performed based on a most recent set of object tracks (equivalently referred to herein as “tracks”) stored in and/or retrieved from the vehicle's tracking subsystem, where the hypotheses are generated based on comparisons between the observations and the existing tracks. Additionally or alternatively, the hypotheses can be generated based on a set of logic and/or rules, a set of models, and/or any other tools.

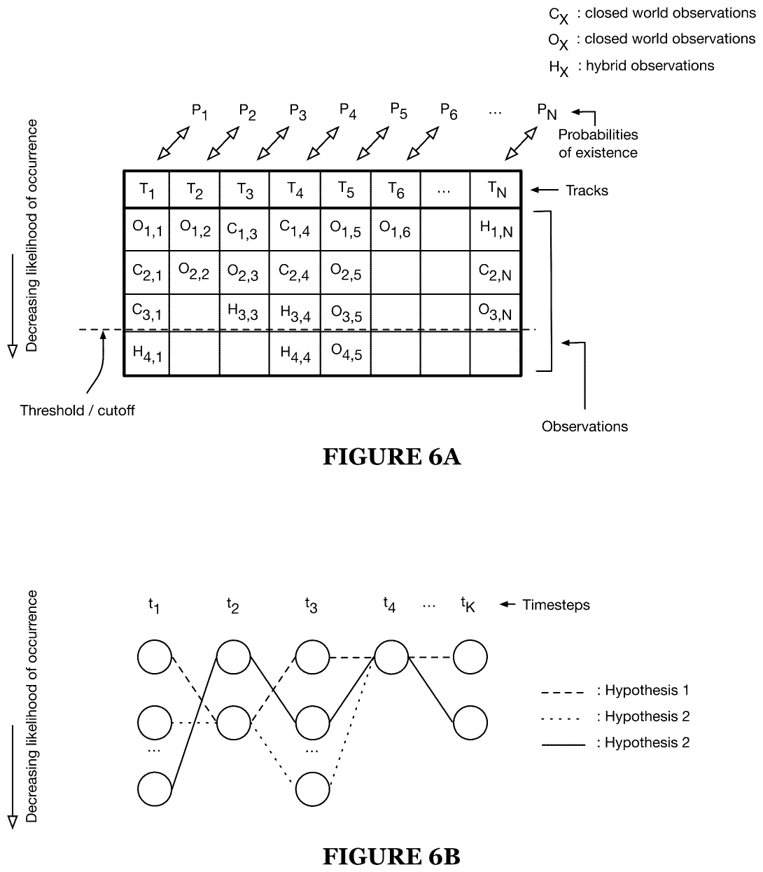

To generate the set of hypotheses, S400 preferably includes comparing each of the set observations (e.g., m+m′) with each of an existing set of tracks in the vehicle's tracker (e.g., as shown in FIG. 6A), where each of the hypotheses relates to if and/or how a particular observation could be used to explain a particular track (e.g., could a 1st observation explain movement of an object corresponding to the 4^{th} track?).

Additionally or alternatively, each track can refer to a set of hypotheses over that track, where the observations are compared against each hypothesis for each track. For instance, in thinking about a modification to the workflow in FIG. 5, each of the 1D arrays shown for each of the N tracks is actually a 2D array where there are N tracks across the horizontal and H hypotheses for each track across the vertical. The comparisons can then be done between every box from a 2D observations matrix to a 2D tracks matrix. The hypothesis generation process can select the K most likely consistent combinations.

For instance, S400 can include determining, for the most recently determined objects and their object tracks, a current set of explanations (equivalently referred to herein as hypotheses) for the progression of each of these tracks (e.g., to propagate the tracks through the time stamp of the sensor data collected in S100) based on the observations, where each track can be explained through a variety of types of observations. For instance, any given track can be explained through: observations produced from a closed world representation (equivalently referred to herein as closed world tracks); observations produced from an open world representation (equivalently referred to herein as open world tracks); and/or hybrid tracks which reflect observations from both the open and closed worlds. In an example shown in FIG. 6A, for instance, observations from the closed world representation are denoted with a “C,” observations from the open world representation are denoted with an “O,” and hybrid observations are denoted with an “H.” This effectively enables the system to identify which observations might correspond to the existing tracks, which observations might result in new tracks, which observations do not correspond to existing or new tracks (e.g., represent noise), and/or any other explanations. In variants, each object can be associated with multiple distinct (e.g., incongruous, etc.) tracks.

Generating the set of hypotheses is preferably performed using a random finite sets evaluation framework, but can additionally or alternatively be performed with any other suitable processes. In examples, the set of hypotheses can be generated full enumeration methods (e.g., enumerating all possible observation-to-track associations, etc.), machine-learning methods (e.g., inference from a learned model), model-based methods (e.g., ANN, RNN, CNN, ML-methods, etc.), gating-based methods (e.g., statistical distance gating, Mahalanobis distance gating, etc.), Finite Set Statistics (FISST) methods, clustering-based methods, likelihood-based methods (e.g., determining track-conditioned observation likelihood, multi-model likelihood evaluation (e.g., calculating hypothesis likelihoods under different possible motion and/or measurement models, etc.), Gaussian mixture likelihood computation, etc.), attribute-based association (e.g., matching features and/or attributes of the observation to the track, etc.) where attributes can include shape, size, speed, heading, and/or other suitable attributes, and/or any suitable combination of the aforementioned methods.

In a first set of examples, likelihood of the hypothesis can a combination of likelihood of a valid Mahalanobis distance, a likelihood of valid cuboid overlap (e.g., between the observation and track hull, etc.), a likelihood of valid semantic overlap, and/or other suitable values. In a second set of examples, an intensity function (e.g., a Poisson component, etc.) represents the density of expected undetected targets in the environment. In examples, the intensity function for pedestrians can be higher on a street corner than in the street (e.g., representing that pedestrians are more likely to occupy the street corner than the street, etc.). The intensity function can be used to determine whether a new observation is more likely to correspond to an existing track or a previously undetected track. In this example, a multi-Bernoulli function can be used to adjust the probability of existence of the track over time.

In preferred variants, S400 is performed based on a set of logic, where the set of logic represents how tracks might evolve and/or how observations could explain such evolutions. For instance, in generating the hypotheses, logic can be evaluated that assesses any or all of: whether or not two objects could be overlaid (and result in an erroneous observations as a single object); whether or not a previously detected single object is actually two objects; whether or not an object was previously mis-classified; and/or any other logic can be implemented.

S400 preferably includes maintaining (e.g., storing, passing along to S500, etc.) all of the hypotheses, wherein subsequent processes of the method can optionally include refining (e.g., decreasing/increasing the likelihood of, etc.) the hypotheses. Alternatively, S400 can include passing along only a subset of hypotheses to S500.

Additionally or alternatively, S400 can include any other suitable processes and/or generating a set of hypotheses S400 may be otherwise performed.

Determining a set of tracks S500 functions to update a prior belief of tracking history for use in planning motion of the ego vehicle. Additionally or alternatively, S500 can perform any other functions.

Tracks can refer to detections of the same real-world object in each of multiple timesteps. Tracks can be associated with a kinematic data (e.g., indicating pose, velocity, acceleration, size, scale, orientation, heading, etc.), temporal data (e.g., time of first observation of object represented by track, current age, last update timestamp, a history of past states, etc.), a probability of existence, track quality, classification (e.g., “truck,” “car,” “pedestrian,” etc.), visual features (e.g., color histogram, texture, etc.), shape parameters, occlusion status (e.g., whether or not a track is currently in a visible region; binary or non-binary occlusion status; etc.) and/or any other suitable information.

In a variant, a bounding hull or set of bounding hulls can be associated with the track based on a classification or set of classifications of the track. In this variant, the bounding hull can be the same or different type of bounding hull as used for an observation (e.g., an observation at a current timestep, etc.). The bounding hull can be the same bounding hull over the entire lifetime of the track, can be the bounding hull corresponding to the highest-likelihood classification corresponding to the track, can be a bounding hull corresponding to a classification hypothesis above a threshold likelihood, and/or a bounding hull of a type determined by any other suitable method. In an example, the bounding hull is updated when new measurements about the detected object are determined.

S500 can include generating new tracks and/or updating existing tracks. In a first variant, an observation determined in S300 is determined to not correspond to any existing track and/or have a low observation likelihood for existing tracks (e.g., an observation likelihood below a threshold value, etc.). In this variant, S500 can include generating a new track to correspond to the observation. In this variant, the observation likelihood and/or probability of existence of the observation and/or track can be 0, 1 (e.g., 100%), a predetermined intermediate value between 0 and 1, a confidence associated with the observation and/or attributes thereof, and/or any other suitable value. In a second variant, an existing track (e.g., determined in S500 in a previous timestep, etc.) is updated in response to and/or based on observations and/or hypotheses determined in S300 and/or S400. The update can include updating a probability of existence of the track, updating an observation likelihood for observations determined at a previous timestep, updating the track itself (e.g., updating track kinematics, etc.), and/or updating any other suitable values associated with the track. However, S500 can operate on and/or update any other suitable information.

S500 is preferably performed by the tracking subsystem 122 but can alternatively be performed by another suitable system component.

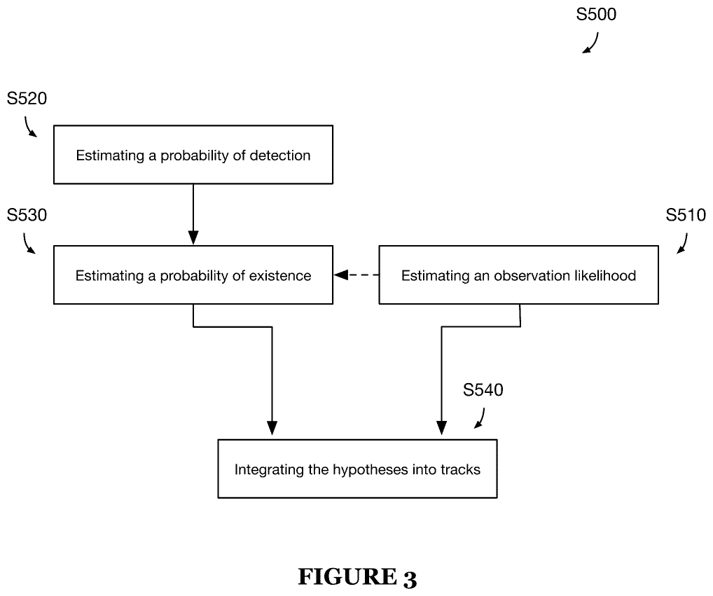

S500 can include estimating an observation likelihood 510, estimating a probability of detection S520, estimating a probability of existence S530, integrating the hypotheses into object tracks S540, and/or any other suitable processes (e.g., an example is shown in FIG. 3).

S500 can include determining an observation likelihood S510. The observation likelihood can quantify how likely it is that a particular observation corresponds to a particular track given the knowledge of that track, and reflects this likelihood for the given frame of data (e.g., only the given frame of data). The observation likelihood can represent how likely it is that a particular observation would be caused by a particular track (e.g., a hypothesis, etc.). In a variant, S510 can be performed during hypothesis generation (e.g., S400, etc.), wherein the observation likelihood can be the likelihood of the hypothesis. In preferred implementations of the method, the observation likelihood can be used to determine which single track is most likely to have caused an observation, such that each observation is linked (e.g., via an optimization process, based on a set of logic such as intersection-over-union logic, etc.) to a single track for subsequent analysis in the method. Alternatively, individual observations can be linked to multiple tracks (e.g., if the observation likelihood exceeds a predetermined threshold in both cases), the linking of each observation to a track can occur earlier in the method (e.g., in S300, in S400, etc.), and/or observations can be otherwise associated with any other information. Additionally or alternatively, multiple observations can be associated with a single track. For instance, one open world observation can be made from a front bumper of the vehicle and another open world representation can be made from a rear bumper of the vehicle. In variants, the observation likelihood can additionally or alternatively be or include probability of existence, an observation score (e.g., representing an attribute of the observation and/or confidence thereof, etc.), and/or any other suitable values.

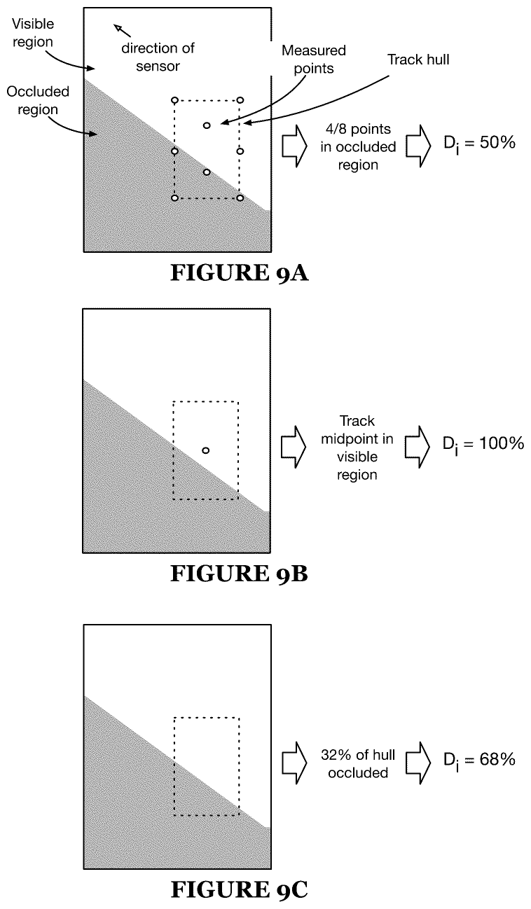

S520 can provide a probability of detection prior for a track and/or observations. S520 can be performed on a track and/or on an observation. In an example, a predicted next position of the object represented by the track can be predicted based on a track heading, trajectory, speed, acceleration, timestep, and/or any other suitable values, and S520 can be performed using the predicted next position of the track. The prediction can be a set of coordinates, a set of coordinates associated with a confidence, probability distribution, and/or any other suitable probabilistic or non-probabilistic value. The probability of detection can refer to the probability that a track and/or an object represented by a track is detectable at a given timestep (e.g., the current timestep, etc.). The probability of detection can be extracted from the visibility representation, but can alternatively be calculated based on the visibility representation. The probability of detection can optionally be based on a probability of detection determined at a previous timestep. The probability of detection can be binary or non-binary. The probability of detection can be discrete, continuous, a probability distribution, single-dimensional, multi-dimensional, and/or can take any other format. In a first variant, the visibility representation can be sampled at a set of points. In a first example, points can be on the bounding hull for a track (e.g., average/volumetric median/modal points, bounding hull corners, edges; example shown in FIG. 9A, etc.). In a second example, points can be distributed (e.g., uniformly, etc.) within a bounding hull. In a third example, points can be a single reference point associated with a bounding hull shape (e.g., example shown in FIG. 9B, etc.). In a fourth example, points can be a region within a bounding hull and/or within a threshold distance of the bounding hull. In a fifth example, points can be data points from measurements (e.g., points in lidar point cloud). In an example, points can be filtered by proximity to the bounding hull of a track. In a second example, points can be observed points which lie within a bounding hull of a track. In a second variant, the visibility representation can be sampled within an area (e.g., example shown in FIG. 9C, etc.). In a first example, the area can be a bounding hull for a track. In a second example, the area can be an area within threshold distance of a track. In a specific example, the percentage of area within visible region can be the probability of detection. The set of points can be used directly (e.g., to query a 3D visibility representation) and/or can be projected and used (e.g., to query a 2D visibility representation, etc.). In a first variant, the track position (e.g., track bounding hull position) can be extrapolated using trajectory of track and timestep since last observation of track (dead reckoning). In a second variant, the track position (e.g., track bounding hull position) can be the most recently-observed position of track, and/or any other position. The track position can include a buffer zone proportional to uncertainty of current tracked object position. The track position can be probabilistic (e.g., a distribution over a region) or, alternatively, deterministic. The queried values (e.g., values extracted from visibility representation at points and/or projected points) can be used directly as the probability of detection, aggregated (e.g., averaged, etc.), filtered by maximum/minimum probability of detection (e.g., with maximum/minimum value used, etc.), and/or any other suitable values. In an example, the probability of detection can be the average value of each of a set of binary values corresponding to points within a boundary hull associated with a track.

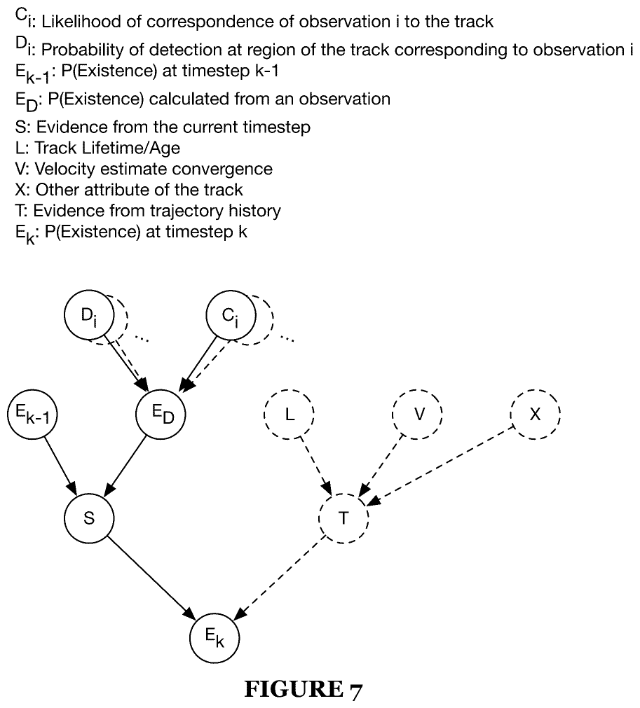

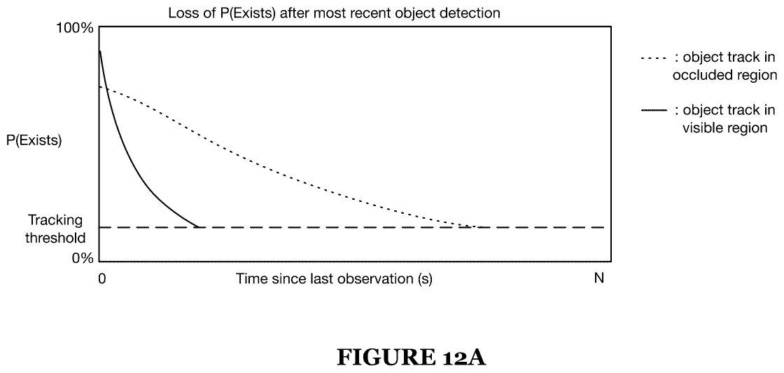

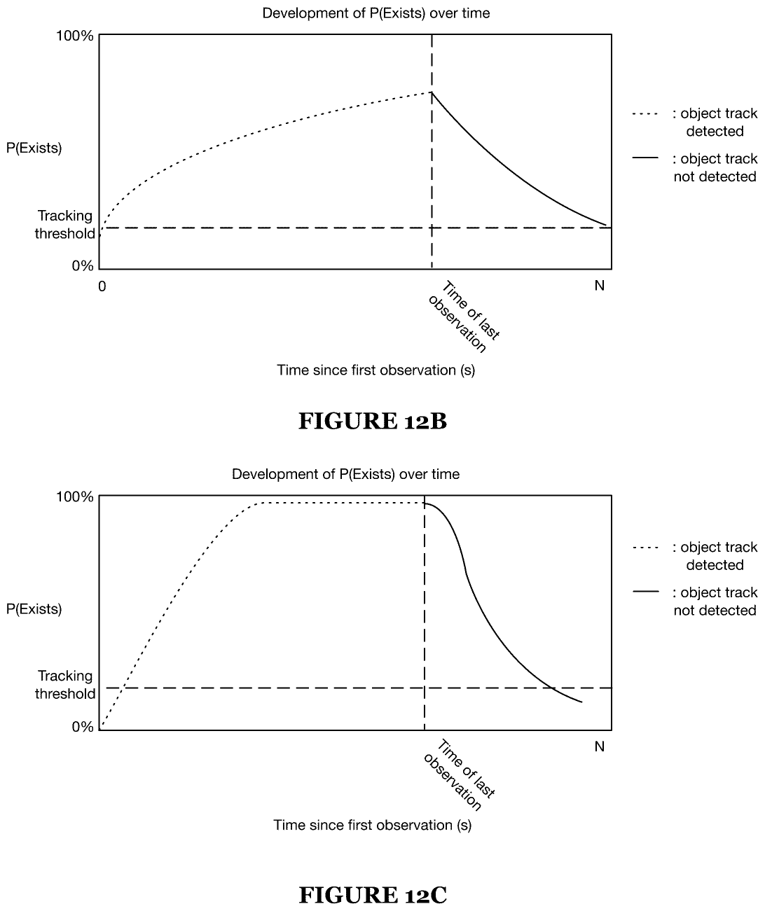

S530 can include updating a probability of existence associated with the object track. The probability of existence (e.g., alternatively referred to herein as a “first metric”) can refer to the probability of existence of an object track, the probability of existence of an object associated with the object track, and/or any other suitable probability of existence. The probability of existence can be associated with each track (e.g., existing track, proposed track, etc.), and can optionally be used to rank hypotheses for different tracks relative to each other (e.g., in order to determine which track an observation is more likely to correspond to, etc.). The probability of existence is preferably updated with each frame (e.g., at each iteration of the method), such that it represents the evolution of the existence of that tracked object. For instance, a plot of the probability of existence over time for an object will slope upward for objects that actually exist as incoming information serves to confirm this object's existence (e.g., example shown in FIG. 12B and FIG. 12C), whereas for an object that was mistakenly identified and/or classified and/or characterized, its probability of existence will decrease in value over time (e.g., gradually, with a large spike upon collecting conflicting sensor data, etc.; example shown in FIG. 12A). Additionally or alternatively, the probability of existence can reflect any other information and/or be otherwise suitably calculated. The probability of existence can represent a probability of existence separate from a confidence associated with an attribute of the object and/or object track. The probability of existence can be 0.1%, 1%, 2% 5%, 10%, 20%, 50%, 80%, 90%, 95%, 99%, 99.9%, within an open or closed range bounded by the aforementioned values and/or any other suitable range. S530 preferably includes dynamically updating a preexisting probability of existence (e.g., from a prior timestep, etc.), but can alternatively estimate probability of existence de novo (e.g., for a new object track, etc.). The probability of existence is preferably determined using a Poisson Multi-Bernoulli Mixturing framework (PMBM), but can additionally or alternatively use log-likelihood ratio (LLR) scoring, Bayesian existence updates (e.g., recursive bayes, etc.), delta-generalized labeled multi-Bernoulli (δ-GLMB), labeled multi-Bernoulli (LMB), Joint Integrated Probabilistic Data Association (JIPIDA), multi-hypothesis tracking (MHT), and/or any other suitable methods for tracking. The S530 process can depend on whether the object and/or object track is observed in the present set of measurements (e.g., when a hypothesis associates an observation with a preexisting object track, wherein a hypothesis has a likelihood above a threshold value, etc.) versus not observed in the present set of measurements. In a first example, probability of existence is scaled up when the object is detected, and is scaled down when the object is not detected. Magnitude and/or type of scaling factor (e.g., in variants where the update comprises applying scaling factor, etc.) used can depend on the probability of detection. In a second example, the method can be performed based on aggregated hypotheses of whether observations correspond to a track (e.g., can determine an overall likelihood of observation of the track) and can scale and/or increment the probability of existence based on the overall likelihood of observation. In a first variant, probability of existence is updated dynamically (e.g., example shown in FIG. 7). In this variant, the probability of existence can be updated at each timestep. In this variant, the magnitude of the update can be a function of multiple variables: preexisting probability of existence for the object and/or object track (e.g., probability of existence from a previous timestep, etc.); a probability of detection for each of the detected objects and/or the object track; a probability of correspondence of each observation to the track (e.g., used to weight the impact of different observations on the updated probability of existence, as in a Poisson Multi-Bernoulli framework, etc.); a continuous or binary score representing whether the object and/or object track is observed (e.g., whether observations depict the object, etc.); a continuous or binary score representing whether an attribute of the object track (including or not including the most recent observation) has converged; track age; and/or any other variables In an example, types of attributes that can converge include shape, size, velocity, classification, heading, and/or any other attributes. The update is preferably calculated using a Bayesian graphical network (e.g., a recursive graphical network; example shown in FIG. 7), but can alternatively use another suitable algorithm. In an example, posterior probability of existence Eₖ for timestep k is a function of probability of existence Eₖ₋₁ for a prior timestep k−1, a probability of detection, a set of probabilities for each of a set of hypotheses (e.g., probabilities that each hypothesis representing a correspondence between a track and a observations is true), a track age, and a set of convergences for the track (e.g., velocity convergence, shape/size convergence, classification convergence, heading convergence, etc.). In a second variant, preexisting probability of existence is scaled by a factor. The factor can be static or dynamic. The dynamic factor can be based on any of the aforementioned variables used in the first variant. The constant factor can be conditioned on whether the object and/or object track is present in a current set of measurements. The probability of existence for the object overall can be determined from a set of probabilities of existence for different tracks. In an example, this can be performed by track existence probability fusion (e.g., marginalizing the probability of existence for all tracks possibly corresponding to the object). In a first variant, probability of existence can be used to determine whether to use or ignore the track (e.g., binary evaluation of the probability of existence satisfying a tracking threshold, example shown in FIG. 7A). The tracking threshold can be 0.1%, 1%, 2%, 5%, 10%, 20%, 30%, 50%, and/or any other threshold. In a second variant, probability of existence can be used to determine how much weight to give the track (e.g., weight=probability of existence). S530 can further include normalizing probabilities of other attributes by the probability of existence of the object and/or object tracks. In an example, this can include normalizing a semantic object identification using the probability of existence. S530 can further include using different functions for updating probability of attribute labels depending on whether the object is detected. In an example, when an object is detected, S530 can determine a probability for the object overall, apply a filter (e.g., a fixed gain filter, etc.) to a probability of an attribute labels (e.g., a semantic classification, etc.), update the probability of existence of the object, and normalize the semantic labels to the probability of existence of the object. When the object is not detected, S530 can inject entropy into the probability of the attribute label, wherein the entropy is proportional to the probability of detection.

S540 can function to update the vehicle's understanding of tracks in the scene. S540 can include updating the probability of existence of the track determined in S530 and/or updating a series of likely hypotheses determined using observation likelihoods determined in S510. S540 preferably includes prioritizing the hypotheses according to likelihood of that hypothesis being valid and/or explaining the current observations. In a variant, S540 as performed in successive iterations of the method can retain a set of hypotheses for each track and can re-order the hypotheses based on the most up-to-date observations determined at the current timestep (e.g., example shown in FIG. 6B, etc.). In this variant, the ordered hypotheses can refer to hypotheses for a track within an open or closed time window and/or at a single timestep. S540 is preferably performed in accordance with a random finite sets framework, but can additionally or alternatively be otherwise performed. The hypotheses can be prioritized using a K-best Murtys algorithm (e.g., finding the k best assignments of hypotheses to tracks), a probability hypothesis density (PHD) approach, a cardinalized probability hypothesis density (CPHD) approach, and/or any other suitable algorithm (e.g., Murty-Lazy, Miller-Stone-Cox, dynamic programming methods, and/or other suitable methods). The use of random finite set theory (e.g., as part of a Bayesian probabilistic statistical analysis) can function to enumerate and follow hypotheses over time, which can account and allow for the possibility that the tracker information (e.g., vehicle tracks, hypotheses, etc.) could be wrong at any given time. This can have advantages over other frameworks, which may keep only the most likely hypothesis (e.g., per track), where in an event that an error occurs during identification of the most likely hypothesis, that error is propagated. Additionally or alternatively, S540 can function to maintain hypotheses from competing representation/observation sets to mitigate errors from a single source. An output of S540 preferably includes a current (e.g., updated) set of object tracks (equivalently referred to herein as “current tracks”); and an associated probability of existence and associated set of prioritized explanations/observations (e.g., observations that can explain the track; as represented in the table in FIG. 6A), which can be appended to a historical record for each of the tracks. In a preferred set of variants, the current set of object tracks refers to an updated set of object tracks (e.g., relative to a prior iteration of the method 200), which can be determined based on the prior set of tracks and the probability of existence. Additionally or alternatively, the current tracks can be determined based on the observation likelihood, probability of existence, and/or any other information. The prioritized explanations for the current tracks are preferably ordered based at least in part on the observation likelihood, but can additionally or alternatively be: ordered based on other information; un-ordered; truncated in response to comparison with one or more thresholds (e.g., wherein only explanations having an observation likelihood above a predetermined threshold are retained); and/or otherwise evaluated. S540 can be otherwise performed. S500 can include any other suitable processes and/or be otherwise performed.

However, determining a set of tracks S500 may be otherwise performed.

Planning a trajectory for the vehicle S600 functions to utilize the analyses in S400 and/or S500 to help the vehicle understand and react to its environment in an accurate, safe, and optimal manner.

S600 is preferably performed in response to S500, but can additionally or alternatively be performed at any other time, in response to any other step, and/or based on any other trigger.

S600 preferably includes transmitting any or all outputs of S500 to a planning subsystem of the vehicle (equivalently referred to herein as “the planner”), where the planner can use the set of tracks, hypotheses for the tracks, observations, attributes of the tracks and/or observations (e.g., semantic classification, shape, size, etc.) representation from the tracker to navigate the ego vehicle, but can additionally and/or alternatively include any other planning operations.

In variants, S600 can include transmitting a subset of the outputs of S500 to the planner. In an example, a most likely explanation for each object track (e.g., the 1st row of data in FIG. 6A) can be sent to and used by the planner to navigate the vehicle.

In variants, S600 can include transmitting all hypotheses (e.g., represented as a probability density) to the planner, where the planner can evaluate the distribution of hypotheses and operate based on this holistic understanding of possibilities.

In variants, the planner can determine a set of vehicle control instructions based on the trajectory and can transmit the control instructions to vehicle components in order to control the vehicle.

S600 can be planning a trajectory for the vehicle, but can alternatively be otherwise performed.

However, planning a trajectory for the vehicle s600 may be otherwise performed.

All or portions of the method can be performed by one or more components of the system, using a computing system, using a database (e.g., a system database, a third-party database, etc.), in conjunction with a remote system, in response to a command and/or request by a user (e.g., teleoperation command), and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUS, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method comprising:
determining a set of measurements with a vehicle sensor suite;
determining an environmental visibility map based on the set of measurements;
using the environmental visibility map and a prior object track, estimating a probability of detection of an object in the environment, wherein the object is associated with the prior object track;
based on the set of measurements, determining an object detection;
updating the prior object track to yield a current object track;
based on the object detection and the probability of detection of the object, determining a probability of existence of the current object track; and
controlling a vehicle based on the current object track and the probability of existence.

2. The method of claim 1, wherein determining the probability of existence comprises using Poisson Multi-Bernoulli Mixturing (PMBM).

3. The method of claim 1, wherein estimating the probability of detection of the object comprises:
predicting a position of the object using a trajectory of the current object track; and
sampling the environmental visibility map using the predicted position of the object.

4. The method of claim 1, wherein the visibility map is a binary map, wherein the probability of detection is non-binary.

5. The method of claim 4, wherein determining the probability of detection comprises sampling multiple values within a boundary hull associated with the current object track.

6. The method of claim 1, further comprising normalizing a semantic classification of the current object track based on the probability of existence, and wherein controlling the vehicle comprises using the semantic classification.

7. The method of claim 1, further comprising:
determining a next set of measurements with the vehicle sensor suite;
determining a next environmental visibility map based on the next set of measurements;
determining that the object is not detected in the next set of measurements;
determining a next probability of detection of the object using the next environmental visibility map and the current object track; and
responsive to the object not being detected, updating the probability of existence of the current object track based on the next probability of detection of the object.

8. The method of claim 1, wherein updating the probability of existence comprises applying a dynamically updating a prior probability of existence.

9. The method of claim 1, wherein determining the environmental visibility map comprises ray tracing from Lidar scans of the set of measurements.

10. The method of claim 1, wherein the environmental visibility map represents visibility from a plurality of sensors of the vehicle sensor suite and is determined based on predetermined relative positions of the plurality of sensors.

11. The method of claim 1, wherein measurements used to determine the environmental visibility map comprise lidar measurements and measurements used to detect the object comprise camera measurements.

12. A method comprising:
determining a set of measurements with a vehicle sensor suite;
determining an environmental visibility representation based on the set of measurements;
using the environmental visibility representation, estimating a probability of detection of an object associated with an object track;
determining that the object is undetected within the set of measurements;
responsive to the determination of the object being undetected within the set of measurements, determining a probability of existence for the object track based on the probability of detection of the object; and
controlling the autonomous vehicle based on the object track and the probability of existence.

13. The method of claim 12, wherein determining the probability of existence comprises applying a dynamic update to a prior probability of existence.

14. The method of claim 12, wherein the object is associated with multiple distinct object tracks.

15. The method of claim 12, wherein measurements used to determine the environmental visibility representation are in a different modality from measurements used to detect the object.

16. The method of claim 12, wherein estimating the probability of detection of the object comprises sampling the visibility representation at multiple indexes.

17. The method of claim 16, wherein the multiple indexes are based on a classification of the object.

18. The method of claim 12, wherein the environmental visibility representation comprises binary values, and the probability of detection is non-binary.

19. The method of claim 12, further comprising normalizing a prior classification of the object track based on the probability of existence.

20. The method of claim 12, wherein determining an environmental visibility representation based on the set of measurements comprises: detecting objects using a classically programmed object detector.
